(19) United States
(12) Patent Application Publication
(10) Pub. No.: US 2014/0244478 A1
(43) Pub. Date: Aug. 28, 2014

(54) DETERMINING A COLLECTION CATEGORY WITHIN A CREDIT REPORT

(71) Applicant: HAROLD DOUGLAS NEILL, Georgetown, TX (US)

(72) Inventor: HAROLD DOUGLAS NEILL, Georgetown, TX (US)

(21) Appl. No.: 13/781,684

(22) Filed: Feb. 28, 2013

(51) Int. Cl. G06Q 40/02

(52) U.S. Cl. CPC G06Q 40/025
USPC 705/38

(57) ABSTRACT

Embodiments for determining if collections within a new or existing credit report are correctly and/or incorrectly categorized are disclosed. Embodiments categorize collections within a credit report, transmit a notification with data identifying if a collection is correctly and/or incorrectly categorized, and/or transmit a notification if a credit report includes a collection for a specific category of collections.

### FIELD OF THE DISCLOSURE

The present disclosure relates generally to determining categories for collections within a credit report. In particular, example embodiments describe techniques for transmitting a notification for collections within a credit report by using keyword and character string analytics.

### BACKGROUND

Insurance fraud occurs when any act is committed with the intent to fraudulently obtain a benefit or advantage to which an individual is not otherwise entitled to. Fraudulent claims account for a significant portion of all claims received by insurance companies, costing the insurance companies claim expenses. There are different types of insurance fraud covering many, if not all, areas of insurance. Fraudulent insurance claims range in severity, from slightly exaggerating claims to deliberately causing damage or accidents, and misrepresenting material or committing material misrepresentation when applying for life or health insurance.

Insurance companies use credit reports to determine eligibility for coverage or rating what benefits individuals are entitled to. A credit report is a negative record of an individual's past borrowing and repaying, which may include information about late payments, bankruptcy, unpaid payments, collections, etc. Credit reports are useful when determining an individual's ability to pay debts and track an individual's repayment of debt. Despite these advantages, there has been much concern over the accuracy of data in credit reports. For example, credit reports frequently have incorrect categorizations of collections.

If a credit report includes incorrect information, then insurance companies may incorrectly determine what benefits an individual is entitled to. To this end, needs exists for efficient and effective systems and methods to determine if collections are categorized correctly within credit reports, and to notify insurance companies if a credit report includes a collection within a specific category of collections.

### SUMMARY

There are numerous types of insurance fraud, including life insurance fraud, health care insurance fraud, automobile insurance fraud, etc. Many individuals and businesses apply for different types of insurances annually. Because there are numerous people applying for insurance annually, the likelihood of insurance fraud is high. Further, due to the overwhelming amount of data within credit reports that comes from a plurality of different sources that may be categorized incorrectly or non-uniformly categorized, ways to uniformly categorize collections within character reports are desired. In specific embodiments, collections related to medical activity may be incorrectly categorized in a credit report. In response to the credit report having incorrectly categorized collections, insurance companies may be prevented or limited from discovering these collections by analyzing the collection categories within the credit report. Based on a credit report, embodiments may assist insurance companies in determining if an individual includes incorrect or misleading information within an insurance application.

If an individual applies for insurance, the individual may fill out insurance forms including biographic information for the individual such as their name, social security number, occupation, date of birth, residence, etc.

In response to receiving an application for an insurance policy, an insurance company may receive data associated with an individual from a plurality of data sources, such as financial institutions, a department of motor vehicles, hospitals, etc. Upon receiving the data associated with the individual, the insurance company may perform a credit check on the individual. The credit check may produce a credit report including biographic information of the user, past payments, collections information associated with outstanding payments, etc. Thus, a credit report may include numerous fields with different types of data. Utilizing a credit report, an insurance company may determine what insurance benefits the individual is entitled to. However, if the credit report includes information that is characterized incorrectly, then the insurance company may incorrectly determine the benefits that the individual is entitled to.

Systems and methods disclosed herein determine if collections within a new or existing credit report are correctly and/or incorrectly categorized, categorize collections within a credit report, transmit a notification with data identifying if a collection is correctly and/or incorrectly categorized, and/or transmit a notification if a credit report includes a collection for a specific category of collections. In response to determining a category for a collection within a credit report, embodiments may assist insurance companies in identifying cases of insurance fraud.

In embodiments, a collections server may receive data within credit reports including information associated with collection from at least one data source. The collection information may include a collection category associated with different types of collections, such as general, medical, automobile, home, etc. The collection information may also include data identifying the service performed that a collection is desired or required. For example, collection information with a medical collection category may include information associated with the source of the outstanding collection. At least one data source may be associated with services that provide credit reports, applications for credit cards, etc.

The collections server may include a category database. The category database may be comprised of entries for collections categories. The collection categories in the database may include keywords, abbreviations, truncations, phrases, terms, or character strings (referred to hereinafter as “keywords”). The keywords may be associated with characters strings that are likely to be within collections information for a collection category within a credit report.

In response to receiving a credit report, the collections server may compare the collections information within the credit report with the keywords within the category database to determine if the collection category for the collection is categorized correctly or categorized incorrectly and/or assign a collection category for a collection.

In response to determining if the collection is categorized correctly or incorrectly and/or assigning a category to a collection, the collections server may determine if there is an alert associated with a collection that is incorrectly categorized or associated with the assigned collection category. If there is an alert, the collections server may transmit a notification including information associated with the determination if the collection is correctly categorized and/or the assigned category of the collection. The notification may include data associated with the alert that configured to be displayed on a graphical user interface of a computing device.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 depicts an example embodiment of a system to determine if collections are correctly categorized within a credit report.

FIG. 2 depicts an example embodiment of example components of a collections server.

FIG. 3 depicts an example embodiment of a method for transmitting an alert.

FIG. 4 depicts an example embodiment of a method for transmitting an alert.

Corresponding reference characters indicate corresponding components throughout the several views of the drawings. It should be appreciated that elements in the figures are illustrated for simplicity and clarity and have not necessarily been drawn to scale. For example, the dimensions of some of the elements in the figures may be exaggerated relative to other elements to help improve understanding of various embodiments of the present disclosure. Further, common but well-understood elements that are useful or necessary in a commercially feasible embodiment are often not depicted in order to facilitate a less obstructed view of the various embodiments of the present disclosure.

### DETAILED DESCRIPTION

In the following description, numerous and specific details are set forth in order to provide a thorough understanding of the present invention. It will be apparent, however, that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it should be appreciated that the figures provided herewith are for explanation purposes that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

Embodiments disclosed herein are directed towards determining if collections information within a credit report is correctly categorized and/or determining a collections category for a collection. In embodiments, a collections server may receive a credit report. In response to receiving the credit report, the collections server may determine the collections section of the credit report, and determine what data is within the collections section. The collections section of the credit report may include collection information identifying the type of a collection, a summary of the collection, and/or an amount of the collection.

In embodiments, the collections server may compare collection information with entries within a database table to determine if the type of the collection is correctly categorized based on a summary of the collection. In response to determining the type of the collection, the collections server may transmit a notification to a computing device including data indicating the category of the collection. In embodiments, a notification may be transmitted if the collections server determines that a collection within a credit report has been incorrectly categorized and/or is a specific type of collection.

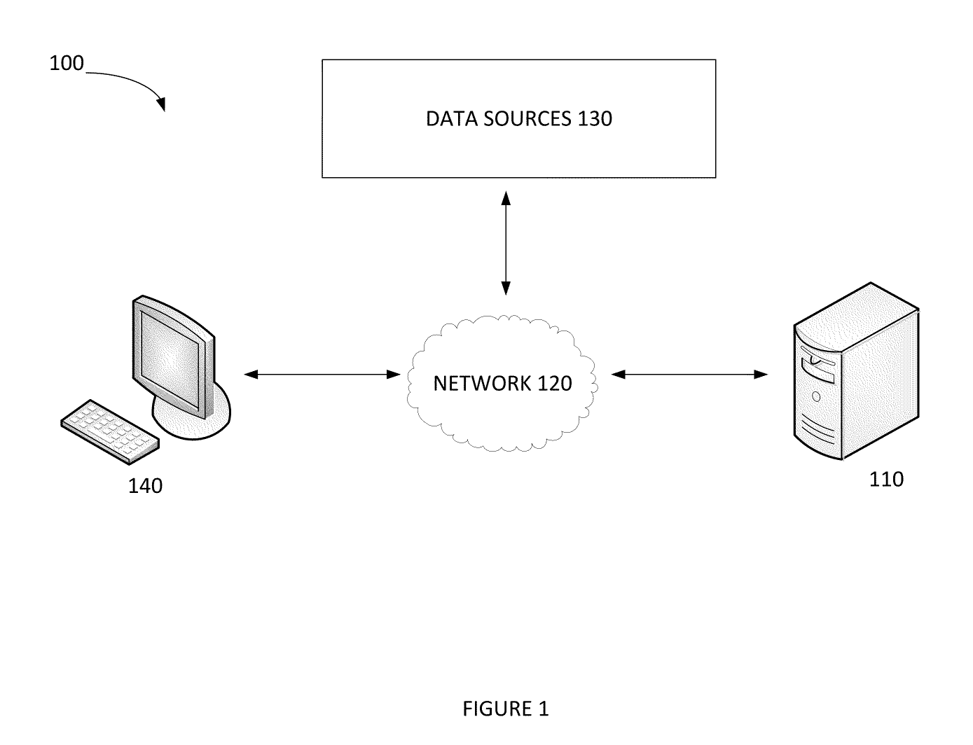

Referring now to FIG. 1, a system typology 100 including a collections server 110 in communication with data sources 130 and a computing device 140 via a network 120 is depicted. Network 120 may be a wired or wireless network such as the Internet, an intranet, a LAN, a WAN, a cellular network or another type of network. It will be understood that network 120 may be a combination of multiple different kinds of wired or wireless networks.

Collections server 110 may be a computing device such as a general hardware platform server that is capable of supporting applications, software and the like. Collections server 110 may include physical computing devices residing at a particular location or may be deployed in a cloud computing network environment. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Collections server 110 may include any combination of one or more computer-usable or computer-readable media. For example, collections server 110 may include a computer-readable medium including one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and/or a magnetic storage device. Collections server 110 may include any combination of one or more computer-usable or computer-readable media.

In embodiments, collections server 110 may be configured to receive data, such as a credit report, from data sources 130. The information received by collections server 110 may be associated with an individual applying for insurance, validating an insurance policy for the individual, modifying an insurance policy for an individual, etc. In response to receiving data, collections server 110 may compare the collections information with the keywords within a database to determine a category for a collection and/or determine if the collection category for the received data is categorized correctly or categorized incorrectly. To determine a category for a collection and/or determine if the collection is categorized correctly, collections server 110 may parse a received credit report to determine collection information including, a category of a collection, a description of the collection, and/or an amount of the collection. Collections server 110 may determine a category of the collection based on the description of the collection and/or by comparing character strings within the description of the collection with keywords within the database.

If the character strings within the description of the collection match a keyword within the database, collections server 110 may determine the category of the collection is the collection category associated with the matching keyword. In response to determining a collection category for the keyword within the database, classification server 110 may compare the determined classification category for the collection with the collection category for the collection within the credit report. If the collection categories are the same or substantially similar, collections server 110 may determine that the collection category is correct. However, if the collection categories are not the same, collections server 110 may determine that the collection category is categorized incorrectly on the credit report. In response to determining a collection category for a collection and/or if the collections information is categorized correctly or incorrectly, collections server 110 may transmit a notification including information configured to be displayed on a graphical user interface of data sources 130 or computing device 140 indicating the result of the determinations.

Data sources 130 may include at least one data source including financial institutions, medical providers, credit reporting services, biographic reporting services, etc. One example of a data source 130 may be Equifax Secure Inc. Data sources 130 may include a computing device with a hardware processor that is configured to process instructions, and connect to and transmit data over network 120 to collections server 110, computing device 140 and/or any type of device that may assist in validating or in confirming a collections record within a credit report. In embodiments, data sources 130 may transmit data associated with information to identify an individual applying for or having an insurance policy. The transmitted data may include a social security number, name, address, occupation, phone number, utility bills, medical bills, telephone bills, credit reports, etc. The transmitted data may also include information from a medical provider such as attending physicians statements, hospital reports, lab test results, and/or any other information that from a medical provider.

Computing device 140 may be a desktop computer, smart phone, tablet computer, laptop computer, personal data assistant or any other type of computing device with a hardware processor that is configured to process instructions and connect to network 120, one or more portions of network 120, collections server 110, data sources 130 and/or any type of device that may assist in validating a collections record within a credit report. Computing device 140 may be configured to receive a notification transmitted by collections server 110. The received information may be configured to identify a category of a collection and/or whether the collection is categorized correctly. Computing device 140 may present the received data to a user on a graphical user interface of computing device 140. In response to a user viewing the received data on the graphical user interface of computing device 140, the viewer may provide instructions for computing device 140 to transmit data associated with the collections within the credit report to data sources 130, such as an insurance company, medical provider, or any other party. The transmitted data from computing device 140 may be utilized to notify a data source 130 of a previously reported medical collection, previously uncollected collection, or any other relevant information that may not disclosed by an individual or which may be incorrectly categorized on the credit report.

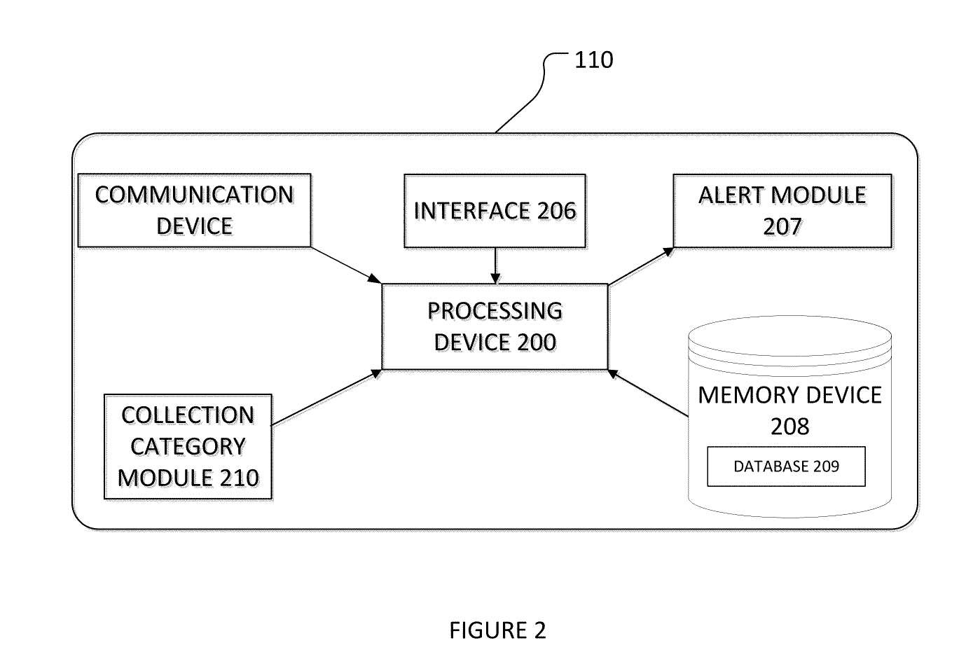

FIG. 2 is an embodiment of a block diagram depicting example components of collections server 110. As shown in the illustrative example, collections server 110 includes a processing device 200, a communication device 204, an interface 206, an alert module 207, a memory device 208, and collection category module 210.

Processing device 200 can include memory, e.g., read only memory (ROM) and random access memory (RAM), storing processor-executable instructions and one or more processors that execute the processor-executable instructions. In embodiments where processing device 200 includes two or more processors, the processors can operate in a parallel or a distributed manner. Processing device 200 can execute an operating system of collections server 110 or software associated with other elements of collections server 110.

Communication device 204 may be a device that allows collections server 110 to communicate with another device, e.g., data sources 130 and/or computing device 140 via network 120. Communication device 204 may include one or more wireless transceivers for performing wireless communication and/or one or more communication ports for performing wired communication. In embodiments, communication device 204 may be configured to receive a credit report associated with an individual and an insurance policy. For example, communication device 204 may receive a credit report for an individual desiring to obtain a life insurance policy. The credit report may include collection information associated with outstanding collections that the individual may have. The collections information may include a collection category associated with the types of collection, such as general, medical, automobile, home, etc. The collection information may also include collection description identifying the service performed that the outstanding collection. For example, collection category may include information associated with an individual having an outstanding collection for a medical collection category with a collection description identifying the source of the outstanding collection.

Interface 206 may be a device that allows a user to interact with the collections server 110. While one interface is shown, the term “interface” can include but is not limited to being, a touch screen, a physical keyboard, a mouse, a microphone, and/or a speaker. Interface 206 may include a display configured to present images and/or data to the user. Interface 206 may also include inputs where the user may give instructions to collections server 110.

Alert module 207 may be a device configured to receive instructions to generate an alert. In embodiments, the alert may be associated with if a category of collections is within a credit report, whether a collection is incorrectly categorized within a credit report, and/or a combination. Alert module 207 may generate an alert based on receiving instructions via interface 206 to generate the alert for a category of collections. The alert may trigger the transmission of a notification to computing device 140, wherein the notification may indicate a received credit report includes a collection for a category of collections, an incorrectly categorized collection, and/or a combination.

Memory device 208 may be a device comprising an electronic storage media that electronically stores information. The electronic storage media of memory device 208 may include one or both of system storage that is provided integrally (i.e., substantially non-removable) with collections server 110 and/or removable storage that is removably connectable to collections server 110 via, for example, a port (e.g., a USB port, a firewire port, etc.) or a drive (e.g., a disk drive, etc.). Memory device 208 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Memory device 208 may include one or more virtual storage resources (e.g., cloud storage, a virtual private network, and/or other virtual storage resources). Memory device 208 may store software algorithms, information determined by collection category module 210, information received via communication device 204, information received from data sources 130 and/or computing device 140, and/or other information that enables collections server 110 to function as described herein. Memory device 208 may include a database 209.

Database 209 may include entries for at least one category of collections. For example, database 209 may include entries for a general category of collections, a medical category of collections, a mortgage category of collections, a utility bill category of collections, etc. For each collection category, database 209 may include at least one keyword, which may be a character string likely to be within a description of a collection within a credit report for the associated collection category. The keywords may be used to assign a category to a collection and/or determine if a collection is categorized correctly. For example, an entry in database 209 associated with a medical category of collection may include keywords such as a name of a medical provider, type of medical service, doctor, hospital, hos, doc, dr., heart, procedure, transplant, MRI, abbreviations of the medical terms, truncations of medical terms, etc. In embodiments, the keywords may also be associated with information that may be provided in an attending physician's report, such as keywords associated with an individual's lifestyle habits. The keywords associated with the individual's habits may include data associated with whether the individual smokes, drinks alcoholic beverages, etc.

The keywords within the database 209 may be dynamically modified at any time via a computing device, such as computing device 140 depicted in FIG. 1. Further, new categories of collections may be dynamically created via a computing device.

Collection category module 210 may be a device configured to compare collection information within a credit report with keywords stored within database 209. In embodiments, collection category module 210 may be configured to compare data within collection information within a credit report with the keywords within database 209 to determine a collection category for the collection. If the collections information within the credit reports matches at least one keyword for an entry within database 209, collection category module 210 may determine that the collection category for the collection as the collection category for the keyword within database 209. Further, collection category module 210 may be configured to determine if the collection category for the collection within the credit report matches the collection category of the keyword within database 209 by comparing the collection category of the keyword within database 209 and the collection category of the collection within the credit report. The comparison may determine if the collection information is categorized correctly or incorrectly. If the collection category for the keyword in database 209 that is within the description of the collection is the same as the collection category identified in the credit report, the collection category module 210 may determine that the collection is correctly categorized. However, if the collection category for the keyword in database 209 that is within the description of the collection is different than the collection category identified in the credit report, the collection category module 210 may determine that the collection is incorrectly categorized. If the collections information is categorized correctly or incorrectly, the collections category module 210 may transmit a notification including information configured to be displayed on a graphical user interface indicating the result of the determination. In further embodiments, collections category module 210 may transmit a notification including the determined category of the collection as determined by collection category module 210. For example, in embodiments, if collection category module 210 determines that a collection is categorized as a “medical” category, then collection category module 210 may transmit a notification indicating the collection includes a medical collection. In further embodiments, collection category module 210 may be configured to transmit a notification if a collection amount associated with the collection is greater than or less than an amount threshold. The amount threshold may be dynamically created and may vary based on collection category. Therefore, in embodiments, collection category module 210 may transmit notifications for collections that are determined to be in a specific category and for collections with desired amounts.

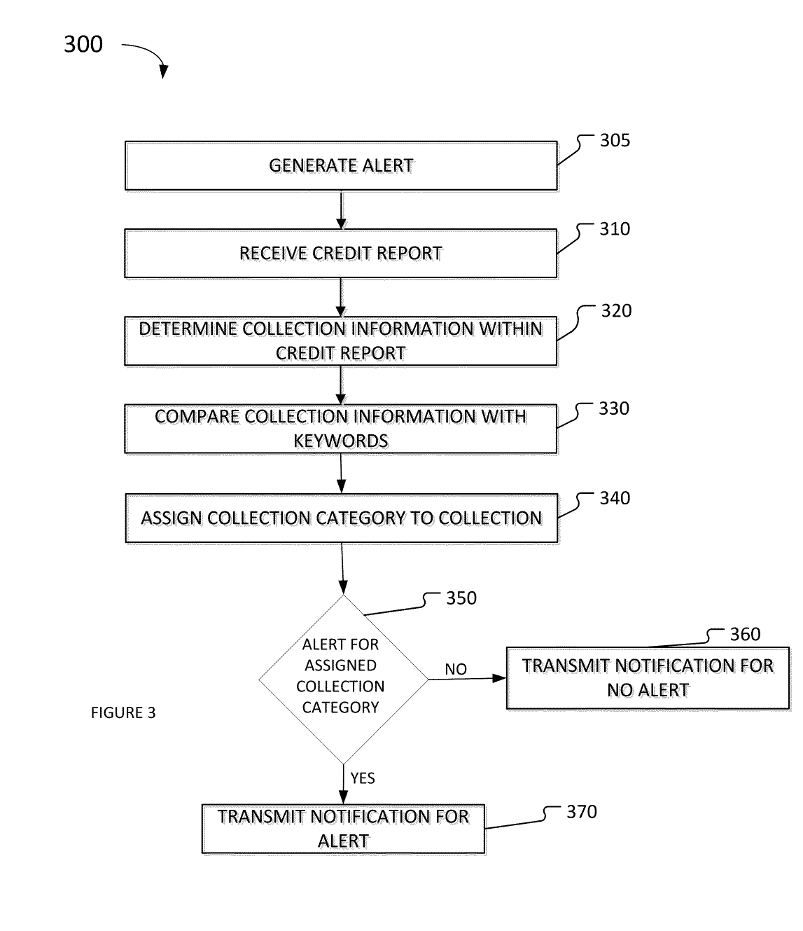

Turning now to FIG. 3, an example method for determining a category of a collection within a credit report is detected. In the illustrated example, the method 300 may executed by a processing device of collections server 110. It is noted that method 300 is presented as a non-limiting example, and other embodiments steps recited in method 300 may be omitted, rearranged or additional steps may be included.

At operation 305, a collections server may receive instructions to generate an alert for at least one category of collections. The instructions may also be associated with specific keywords within a description of a collection. In response to receiving the instructions to generate the alert for the category of collections, collections server may generate instructions to transmit a notification to a computing device if a received credit report includes a collection for the category of collections associated with the alert. In an embodiment, an alert may be generated for a category of collections associated with medical collections.

At operation 310, the collections server may receive a credit report. The credit report may be associated with an individual, and in embodiments may be received in response to the individual desiring to apply for and/or adjust an insurance policy. The credit report may include information associated with at least one outstanding collection that the individual may have. The collection information may include a category for the collection, a description of the collection, and an amount of the collection. In embodiments, the description of the collection may include character strings associated with a visit to a doctor, hospital, etc. However, the category for the collection in the collection report may be incorrectly categorized. For example, instead of the collection category within the category being categorized as a medical category, the collection category within the credit report may be categorized as a general category of collections.

At operation 320, the collections server may parse the credit report to determine the collection information. In embodiments, the collections server may parse the credit report to determine a category for a collection, a description of the collection, and the amount of the collection.

At operation 330, the collections server may compare character strings within the description of the collection with keywords stored within a database. In embodiments, each of the keywords within the database may be associated a category of collections.

At operation 340, the collections server may assign a collection category for the collection within the database. The collections server may determine a category for a collection if a character string within the description of the collection matches a keyword within an entry of the database. The collections server may assign the collection category for the collection as the collection category or the matching keyword within the database. For example, a description of a collection may include a character string such as “Hospital visit with Dr. Jones.” If keywords for a medical collections category within the database include character strings such as “hospital” and/or “dr.” The collections server may assign the collection to the medical collections category.

At operation 350, the collections server may determine if the assigned collection category for the collection is associated with a collection category having an alert for. At operation 360, if there is not an alert for the assigned collection category, then at operation 360 the collections server may transmit a notification to a computing device indicating that the credit report did not include a collection with an assigned category associated with an alert. At operation 350, if there is an alert for the assigned collection category, then at operation 370 the collections server may transmit a notification to a computing device indicating that the credit report did include a collection with an assigned category associated with an alert. For example, if collections server has an alert for a medical collections category and a collection within a credit report is assigned to a collection category, the collections server may transmit a notification to a computing device. In embodiments, the notification may include data associated with an indicator for the assigned category, the credit report, information within the credit report for the collection, and/or any other pertained information.

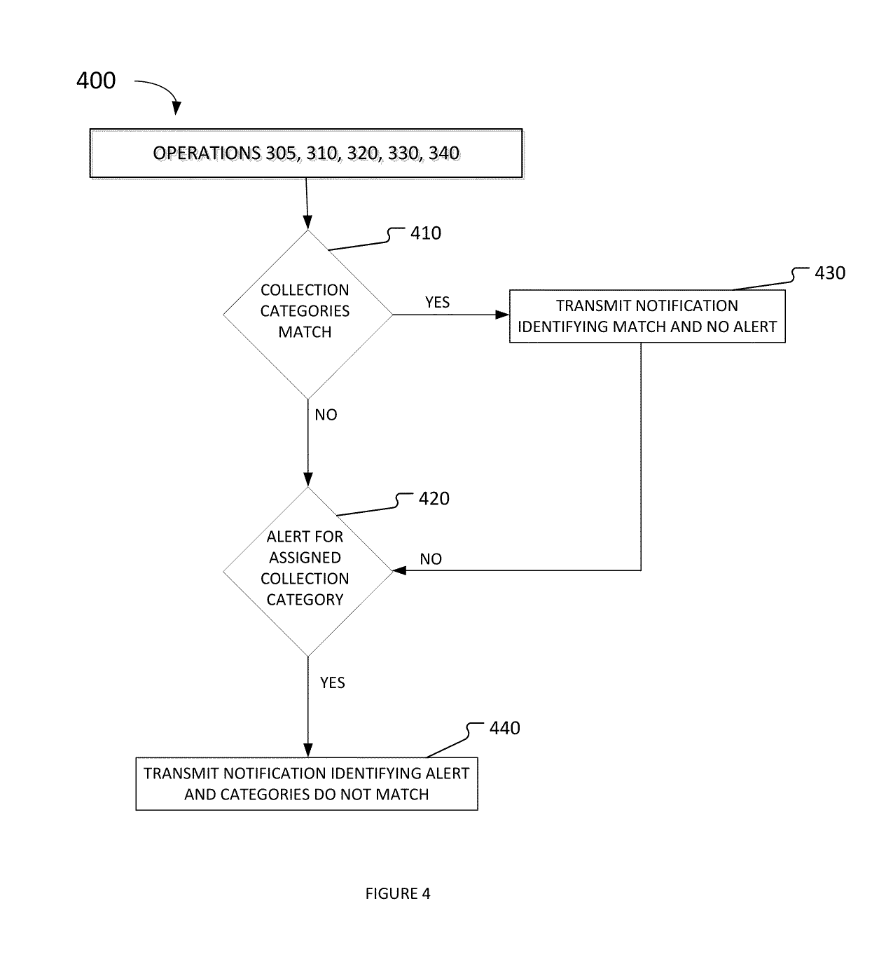

FIG. 4 depicts an example method for determining a category of a collection within a credit report is detected. In the illustrated example, the method 400 may executed by a processing device of collections server 110. It is noted that method 400 is presented as a non-limiting example, and other embodiments steps recited in method 300 may be omitted, rearranged or additional steps may be included. In FIG. 4, operations 305, 310, 320, 330, 340, may be substantially the same as those described above in FIG. 3, therefore a further description of those operations is omitted for the sake of brevity.

At operation 410, a collections server may compare the collection category for the collection within the credit report with the collection category of the keyword within database to determine if the collection categories match or are substantially the same. If the collection categories are different, method 400 may continue to operation 420. If the operations are the same or substantially the same, method 400 may continue to operation 430.

At operation 420, the collections server may determine if the assigned collection category for the collection is associated with a collection category having an alert for. At operation 420, if there is an alert for the assigned collection category, then at operation 440 the collections server may transmit a notification to a computing device. The notification may include data indicating that the credit report includes a collection with an assigned category associated with an alert and that the collection is incorrectly categorized.

At operation 430, if the determined category for the collection is the same or substantially the same as the collection in the credit report and there is not an alert for the determined collection category, then at operation 430 the collections server may transmit a notification to a computing device. The notification may include data indicating that the collection is correctly categorized and the credit report did not include a collection with an assigned category associated with an alert.

Accordingly, embodiments may identify credit reports having misreported collections. Embodiments may also alert an insurance company, a medical provider or other interested party to a possibly previously report collection, such as a medical collection, not disclosed by a customer or a potential customer.

The above description of illustrated examples of the present disclosure, including what is described in the Abstract, are not intended to be exhaustive or to be limitation to the precise forms disclosed. While specific embodiments of, and examples for, the disclosure are described herein for illustrative purposes, various equivalent modifications are possible without departing from the broader spirit and scope of the present disclosure. Indeed, it is appreciated that the specific examples are provided for explanation purposes and that other values may also be employed in other embodiments and examples in accordance with the teachings of the present disclosure.

What is claimed is:

1. A system for facilitating correct information within credit reports, the system comprising:
a communication module configured to receive a credit report, the credit reporting including information associated with a collection, the information associated with the collection including a credit report collection category and a description of the collection;
a memory device configured to store a keyword within an entry for a category identifier, the category identifier being associated with a collection category;
a collection category module configured to assign the category identifier to the collection in response to comparing character strings within the description of the collection with the keyword; and
an alert module configured to receive instructions to transmit an alert associated with the category identifier, the alert including data associated with the information associated with the collection being configured to be presented on a display of a computing device.

2. The system of claim 1, wherein the category identifier is assigned to the collection if the character strings within the description of the collection match the keyword.

3. The system of claim 1, wherein the alert module is configured to transmit the alert in response to the collection category module assigning the category identifier to the collection.

4. The system of claim 1, wherein the collection category module is configured to determine if the collection is categorized correctly in response to comparing the category identifier with the credit report collection category, wherein the alert module is configured to transmit the alert if the collection is categorized incorrectly.

5. The system of claim 1, wherein the memory device is configured to store a plurality of keywords within the entry for the category identifier.

6. The system of claim 1, wherein the memory device is configured to store a plurality of entries, each of the plurality of entries being associated with a different collection category.

7. The system of claim 1, wherein the keyword is a character string associated with a term corresponding to the collection category.

8. The system of claim 7, wherein the collection category is associated with a medical collection.

9. The system of claim 1, wherein the keyword is a character string associated with a medical term or medical service provider.

10. A computer-implemented method facilitating correct information within credit reports, the method being implemented in a computer system that includes one or more processors executing computer program modules, the method comprising:
receiving a credit report, the credit report including information associated with a collection, the information associated with the collection including a credit report collection category and a description of the collection;
storing a keyword within an entry of database for a category identifier, the category identifier being associated with a collection category;
assigning the category identifier to the collection in response to comparing character strings within the description of the collection with the keyword; and
receiving instructions to transmit an alert associated with the category identifier, the alert including data associated with the information associated with the collection being configured to be presented on a display of a computing device.

11. The method of claim 10, wherein the category identifier is assigned to the collection if the character strings within the description of the collection match the keyword.

12. The method of claim 10, further comprising:
transmitting the alert in response to the collection category module assigning the category identifier to the collection.

13. The method of claim 10, further comprising:
determining if the collection is categorized correctly in response to comparing the category identifier with the credit report collection category, and
transmitting the alert if the collection is categorized incorrectly.

14. The method of claim 10, further comprising:
storing a plurality of keywords within the entry for the category identifier.

15. The method of claim 10, further comprising:
storing a plurality of entries, each of the plurality of entries being associated with a different collection category.

16. The method of claim 10, wherein the keyword is a character string associated with a term corresponding to the collection category.

17. The method of claim 16, wherein the collection category is associated with a medical collection.

18. The method of claim 10, wherein the keyword is a character string associated with a medical term or medical service provider.

19. A system for facilitating correct information within credit reports, the system comprising:
a communication module configured to receive a credit report, the credit reporting including information associated with a collection, the information associated with the collection including a credit report collection category and a description of the collection;
a memory device configured to store a keyword within an entry for a category identifier, the category identifier being associated with a collection category;
a collection category module configured to assign the category identifier to the collection in response to comparing character strings within the description of the collection with the keyword, wherein the category identifier is assigned to the collection if the character strings within the description of the collection match the keyword; and
an alert module configured to receive instructions to transmit an alert associated with the category identifier and being configured to transmit the alert in response to the collection category module assigning the category identifier to the collections, the alert including data associated with the information associated with the collection being configured to be presented on a display of a computing device.

20. The system of claim 19, wherein the collection category module is configured to determine if the collection is categorized correctly in response to comparing the category identifier with the credit report collection category, wherein the alert module is configured to transmit the alert if the collection is categorized incorrectly.
